(19) United States
(12) Patent Application Publication
(10) Pub. No.: US 2011/0088571 A1
(43) Pub. Date: Apr. 21, 2011

(54) PRESS FOR RESEALABLE ZIPPER STORAGE BAGS

(76) Inventor: BRUCE Kelly MARTIN, Holladay, TN (US)

(21) Appl. No.: 12/897,644

(22) Filed: Oct. 4, 2010

Related U.S. Application Data
(60) Provisional application No. 61/252,282, filed on Oct. 16, 2009.

(51) Int. Cl. B30B 13/00; B30B 15/08; B30B 9/00

(52) U.S. Cl. 100/35; 100/219; 100/102

(57) ABSTRACT

A press for resealable zipper storage bags may be formed similar to a clam-shell, with a resiliently deformable material disposed inside the clam-shell. A user may place objects, such as food, into the storage bag and place the storage bag into the press with its zipper portion disposed outside of the closed press. As the press is closed, air is removed from inside the storage bag. The zipper may be closed and the press opened to remove the storage bag.

### CROSS-REFERENCE TO RELATED APPLICATIONS

This application claims the benefit of priority of U.S. Provisional patent application No. 61/252,282, filed Oct. 16, 2009, which is herein incorporated by reference.

### BACKGROUND OF THE INVENTION

The present invention relates to storage devices and, more particularly, to a press for removing air from resealable zipper storage bags.

Conventional food storage systems include heat sealable bags and a electro-mechanical vacuum pump for removing air from the bags. These conventional systems draw air out of the bags and then heat seal the bags. This design requires special bags. When a user wants to open a previously sealed bag, they must cut the sealed section off the bag. In addition, when removing air from the bags with a vacuum, moisture from the product in the bag may be sucked into the vacuum pump, requiring cleaning of the apparatus and possibly causing damage to the pump.

As can be seen, there is a need for an improved storage system that can remove air from common storage bags.

### SUMMARY OF THE INVENTION

In one aspect of the present invention, a press comprises a top portion hingedly attached to a bottom portion, the top portion and the bottom portion including an exterior housing with side members depending about a periphery of the exterior housing, the exterior housing and the side members defining an interior of the top portion and the bottom portion; and a resiliently deformable material disposed in the interior of the top portion and the bottom portion, wherein the side members of the exterior housing of the top portion and the bottom portion are maintained separate when the top portion is closed against the bottom portion and the resiliently deformable material in the respective top and bottom portions presses together between the top portion and the bottom portion.

In another aspect of the present invention, a food storage system comprises press comprising a top portion hingedly attached to a bottom portion, the top portion and the bottom portion including an exterior housing with side members depending about a periphery of the exterior housing, the exterior housing and the side members defining an interior of the top portion and the bottom portion; and a resiliently deformable material disposed in the interior of the top portion and the bottom portion, wherein the side members of the exterior housing of the top portion and the bottom portion are maintained separate when the top portion is closed against the bottom portion and the resiliently deformable material in the respective top and bottom portions presses together between the top portion and the bottom portion; and a storage bag.

In a further aspect of the present invention, a method for storing a food item comprises placing the food item into a resealable storage bag; placing the storage bag, containing the food item, between two pieces of resiliently deformable material; pressing the two pieces of material together to expel air from the storage bag; and closing a seal on the storage bag.

These and other features, aspects and advantages of the present invention will become better understood with reference to the following drawings, description and claims.

### BRIEF DESCRIPTION OF THE DRAWINGS

FIG. 1 is a front view of a press in use with a storage bag, in a closed, latched position, according to an embodiment of the present invention;

FIG. 2 is a front view of the press of FIG. 1 in an open position;

FIG. 3 is a front view of the press of FIG. 1 in a closed, unlatched position;

FIG. 4 is a side view of the press of FIG. 1 is a closed, latched position;

FIG. 5 is a side view of the press of FIG. 1 in an open position; and

FIG. 6 is a perspective view of the press of FIG. 1 in use with a storage bag, in an open position.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a press for resealable zipper storage bags, such as a ZIPLOC® bag. The press may be formed with a clam-shell type configuration, with a resiliently deformable material disposed inside the clam-shell. A user may place objects, such as food, into the storage bag and place the storage bag into the press with its zipper portion disposed outside of the closed press. As the press is closed, air is pushed out from the storage bag by pressure upon the bag generated within the press. The zipper may then be closed and the press opened to remove the storage bag.

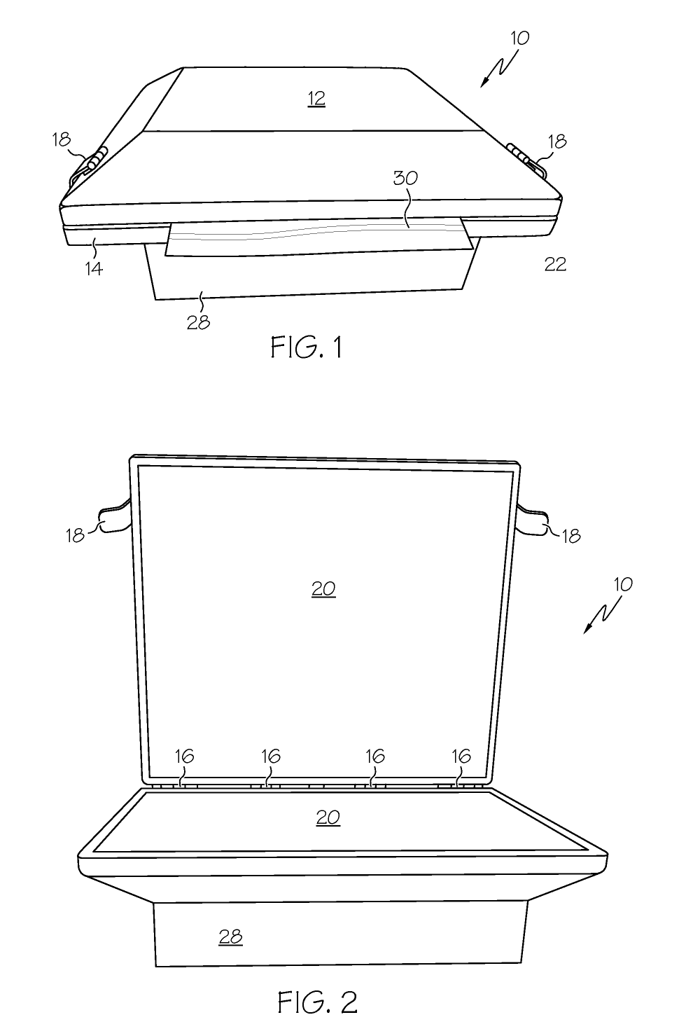

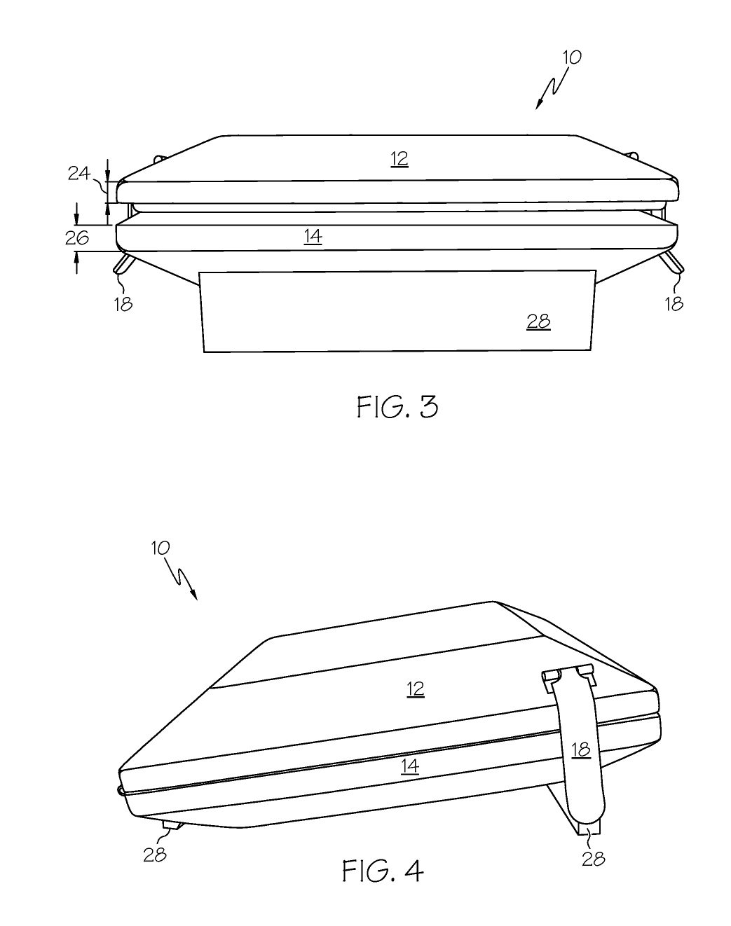

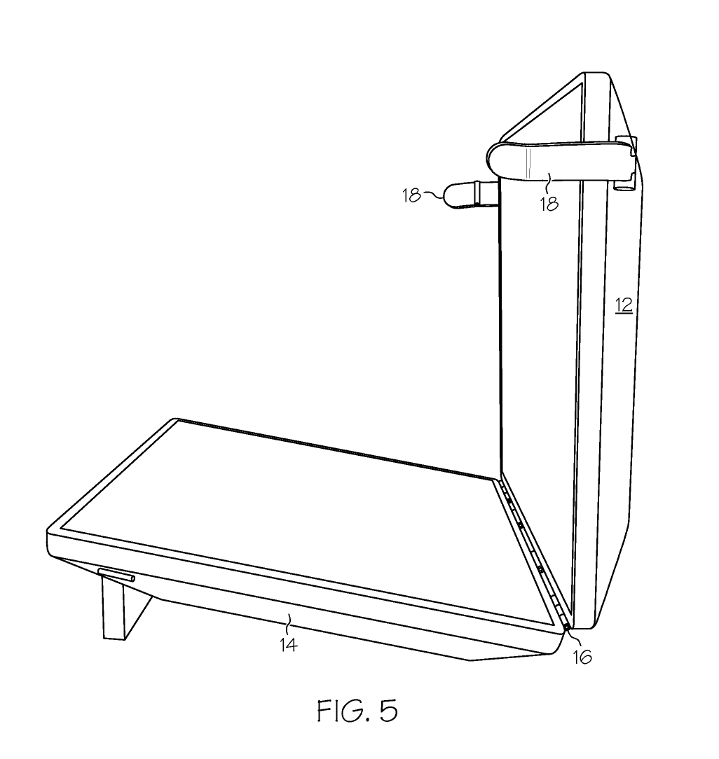

Referring to FIGS. 1 through 6, a press 10 may include a top portion 12 and a bottom portion 14. One of more hinges 16 may connect the top portion 12 and the bottom portion 14. A locking mechanism 18 may be provided to lock the top portion 12 to the bottom portion 14. In some embodiments, the locking mechanism 18 may include first and second locking latches positioned on opposite sides of the press 10. The top portion 12 and the bottom portion 14 may be made from rigid materials, such as high strength plastic, typically an injection molded plastic. The hinge 16 may be formed by injection molding one half of the hinge 16 into each of the top portion 12 and the bottom portion 14. A hinge pin (not shown) may be used to join the two hinge halves.

The top portion 12 may be formed from a top exterior housing 12-1 with side members 12-2 surrounding a periphery of the housing 12-1. The side members 12-2 and the housing 12-1 may define an interior of the top portion 12. The bottom portion 14 may be formed from a bottom exterior housing 14-1 with side members 14-2 surrounding a periphery of the housing 14-1. The side members 14-2 and the housing 14-1 may define an interior of the top portion 14.

The press 10 may contain a resiliently deformable material 20 in the interior of each of the top portion 12 and the bottom portion 14. The material 20 may be disposed in each portion 12, 14 so that, when the press 10 is closed, the material 20 in each portion 12, 14 meets in the area of a plane 22. The material 20 may be, for example, foam rubber. In other embodiments, the material 20 may be memory foam. In alternative embodiments, the material 20 may be formed from an air or water filled bladder. When the press 10 is closed, the side members 12-2 of the top exterior housing 12-1 may be separated from the side members 14-2 of the bottom exterior housing 14-2. In this configuration, as the press 10 is closed, air is pushed out from the storage bag by pressure upon the bag generated within the press by the material 20. If the side members 12-2, 14-2 were to meet when the press 10 was closed, air may be prevented from exiting the storage bag.

The top portion 12 may have a depth 24 from about 1 inch to about 3 inches, typically about 2 inches. The bottom portion 14 may have a depth 26 from about 1 inch to about 3 inches, typically about 2 inches. The top portion 12 and the bottom portion 14 may have substantially the same size. In some embodiments, the portions 12, 14 may be large enough to hold a gallon size resealable zipper storage bag.

The bottom portion 14 may be disposed on one or more supports 28. The supports 28 may include non-skid, non-marking feet (not shown) to help secure the press 10 during use thereof. In some embodiments, supports 28 may be present at a front of the press 10. This design may result in the plane 22 of the material 20 in the top and bottom portions 12, 14 to slope downward from the front to the rear of the press 10. In this configuration, liquid in a bag 30 disposed inside the press 10 may not flow out of the bag 30 due to gravity.

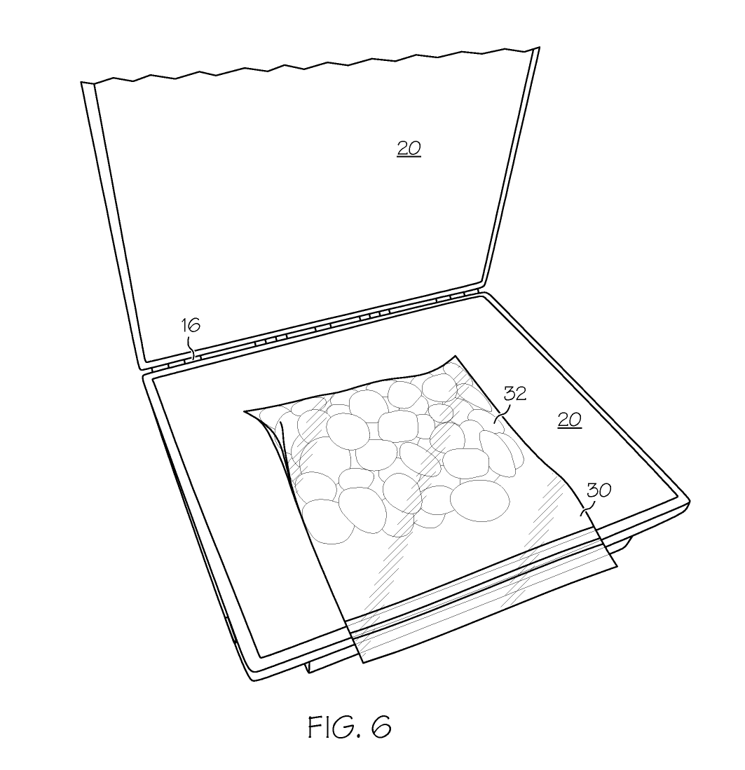

To use the press 10, a user may place an item, such as a food item 32, into the storage bag 30, as shown in FIG. 6. The bag 30, when the lid is open, may remain unsealed. The top portion 12 may be closed on the bottom portion 14 by swinging the top portion 12 toward to bottom portion 14 about the one or more hinges 16. The latches 18 may be closed to ensure the press 10 is fully closed. As the press 10 is closed, the material 20 may deform about the food item 32 and displace air from inside the bag 30 to outside of the bag 30. The zipper seal (or some other seal of the bag 30) may extend outside of the closed press 10. With the latches 18 locked, the zipper seal of the bag 30 may be closed, the latches 18 unlocked, and the top portion 12 opened from the bottom portion 14. The bag 30, closed with air removed therefrom, may be removed from the press 10 and stored accordingly.

While the description above, with reference to the drawings, describe a rectangular press 10, other shape may be within the scope of the present invention. For example, a square press 10 may be designed. Alternatively, the corners may be rounded, or the entire press may be round, oval or the like.

It should be understood, of course, that the foregoing relates to exemplary embodiments of the invention and that modifications may be made without departing from the spirit and scope of the invention as set forth in the following claims.

What is claimed is:

1. A press comprising:
a top portion hingedly attached to a bottom portion, the top portion and the bottom portion including an exterior housing with side members depending about a periphery of the exterior housing, the exterior housing and the side members defining an interior of the top portion and the bottom portion; and
a resiliently deformable material disposed in the interior of the top portion and the bottom portion,
wherein the side members of the exterior housing of the top portion and the bottom portion are maintained separate when the top portion is closed against the bottom portion and the resiliently deformable material in the respective top and bottom portions presses together between the top portion and the bottom portion.

2. The press of claim 1, further comprising at least one locking mechanism adapted to retain the top portion closed against the bottom portion.

3. The press of claim 2, wherein the at least one locking mechanism includes a first locking clasp and a second locking claps, the first and second locking clasps disposed on opposite sides of the press.

4. The press of claim 1, further comprising at least one support member attached to the exterior housing of the bottom portion.

5. The press of claim 4, wherein the at least one support member supports a front side of the press at a higher elevation as compared to a back side of the press.

6. The press of claim 1, wherein the resiliently deformable material is foam.

7. The press of claim 1, wherein the top portion and the bottom portion each have a depth from about 1 inch to about 3 inches.

8. The press of claim 1, wherein the exterior housing and the side members of both the top and bottom portions are formed as a single piece.

9. A food storage system comprising:
press comprising:
a top portion hingedly attached to a bottom portion, the top portion and the bottom portion including an exterior housing with side members depending about a periphery of the exterior housing, the exterior housing and the side members defining an interior of the top portion and the bottom portion; and
a resiliently deformable material disposed in the interior of the top portion and the bottom portion,
wherein the side members of the exterior housing of the top portion and the bottom portion are maintained separate when the top portion is closed against the bottom portion and the resiliently deformable material in the respective top and bottom portions presses together between the top portion and the bottom portion; and
a storage bag.

10. The food storage system of claim 9, wherein the storage bag is a resealable zipper storage bag.

11. The food storage system of claim 9, wherein the resealable zipper storage bag is adapted to fit between the top portion and the bottom portion.

12. The food storage system of claim 9, further comprising a first locking clasp and a second locking clasp, the first and second locking clasps, disposed on opposite sides of the press, adapted to retain the top portion closed against the bottom portion.

13. The food storage system of claim 9, further comprising at least one support member attached to the exterior housing of the bottom portion, wherein the at least one support member supports a front side of the press at a higher elevation as compared to a back side of the press.

14. A method for storing a food item, comprising:
placing the food item into a resealable storage bag;
placing the storage bag, containing the food item, between two pieces of resiliently deformable material;
pressing the two pieces of material together to expel air from the storage bag; and
closing a seal on the storage bag.

15. The method of claim 14, wherein the two pieces of material are each held within a top portion and a bottom portion, the top portion and bottom portion hingedly connected.

16. The method of claim 14, further comprising latching at least one locking mechanism to hold the two pieces of material together prior to closing the seal on the storage bag.

17. The method of claim 14, further comprising leaving the seal of the storage bag outside of a region where the two pieces of material meet.
